(19) United States
(12) Patent Application Publication
(10) Pub. No.: US 2026/0343682 A1
(43) Pub. Date: Oct. 29, 2026

(54) HAND WARMER

(71) Applicants: Di HUANG, Shenzhen (CN); Shenzhen Gaiatop Network Technology Co., Ltd., Shenzhen (CN)

(72) Inventor: Bei ZOU, Shenzhen (CN)

(73) Assignees: Di HUANG, Shenzhen (CN); Shenzhen Gaiatop Network Technology Co., Ltd., Shenzhen (CN)

(21) Appl. No.: 19/394,934

(22) Filed: Nov. 20, 2025

(30) Foreign Application Priority Data
Apr. 29, 2025 (CN) 202520837161.X

(51) Int. Cl. H05B 3/06

(52) U.S. Cl. CPC H05B 3/06

(57) ABSTRACT

The present invention relates to an energy-saving hand warmer designed for efficient use. It consists of two shells, each composed of a base plate, a first casing, and a second casing. Control buttons, magnets, a circuit board, and a battery are embedded in the base plate. The shells can be magnetically attached to form a single larger warmer or used separately. A status indicator light and pressure sensors are integrated to detect idle states, automatically turning off the power to prevent energy waste, thereby achieving energy-saving effects.

### CROSS-REFERENCE TO RELATED APPLICATIONS

The application claims priority to Chinese patent application No. 202520837161.X, filed on Apr. 29, 2025, the entire contents of which are incorporated herein by reference.

### TECHNICAL FIELD

The present invention relates to the technical field of hand warmers, specifically to an energy-saving hand warmer.

### BACKGROUND

The present invention relates to the technical field of hand warmers, specifically to an energy-saving hand warmer. In cold winter weather, many people use hand warmers for portable use. Hand warmer products generally fall into two categories: electric heating pads and soft liquid hand warmers. Small hand warmers are compact in structure, easy to carry at any time, and can be used in a pocket.

Currently, handheld hand warmers typically integrate the switch and gear adjustment functions into a single button. For example, a long press of the button can turn the hand warmer on or off, while a short press can adjust the temperature. This method has a higher degree of integration and is easier to manufacture. However, during actual use, users may forget to turn off the power after using the hand warmer, leading to unnecessary energy waste. Therefore, there is an urgent need for an energy-saving hand warmer.

### SUMMARY

To solve the above technical problems, the present invention provides the following technical solution: an energy-saving hand warmer, comprising a first shell and a second shell. Both the first shell and the second shell are composed of a base plate, a first casing, and a second casing. The outer side of the base plate is equipped with control buttons, and the base plate is provided with two rectangular magnets, a circuit board, and a battery. The first casing is fitted over the surface of the second casing, and an electric heating element is arranged between the first casing and the second casing to heat the first casing. Additionally, a prompt module is arranged on the first casing to detect whether the hand warmer is turned on.

Preferably, the surface of the base plate is provided with two sets of slots, and the magnets are embedded within these slots.

Preferably, a heat insulation pad is arranged on the surface of the side of the battery that is close to the second casing.

Preferably, the outer wall of the second casing is provided with a mounting groove, and the electric heating element is arranged in the mounting groove, with the outer wall of the electric heating element fitting closely against the inner wall of the first casing.

Preferably, an outer rim is arranged on the edge of the inner base plate of the first shell, and the sides of the first shell and the second shell that are close to each other are fitted together through the outer rim.

Preferably, the prompt module includes two pressure sensors symmetrically installed on the surface of the first casing, and a status indicator light is also arranged at the center of the top of the first casing.

Preferably, the outer side of the base plate is further provided with a display screen for displaying the battery level.

With the above technical solution, the present invention provides an energy-saving hand warmer with at least the following beneficial effects: First, the first and second shells can be magnetically attracted to combine into a large hand warmer after fitting together, or they can be separated into two independent hand warmers for separate use, offering better adaptability. Additionally, a status indicator light and pressure sensors are arranged on the exterior of the first casing. The status indicator light serves as a more noticeable reminder to the user of whether the power is turned off. At the same time, the pressure signals detected by the pressure sensors can be used to determine whether the hand warmer is in an idle state, automatically turning off the power to prevent energy waste and achieve energy-saving effects.

### BRIEF DESCRIPTION OF DRAWINGS

These and other features and advantages of the present invention will become better understood with regard to the following description and accompanying drawings in which:

FIG. 1 illustrates a schematic view of the external structure of the present invention;

FIG. 2 illustrates a schematic view of the first perspective of the disassembly of the second shell in the present invention;

FIG. 3 illustrates a schematic view of the second perspective of the disassembly of the second shell in the present invention.

In the drawings: 1. First shell; 2. Second shell; 3. Base plate; 4. First casing; 5. Second casing; 6. Control button; 7. Magnet; 8. Circuit board; 9. Battery; 10. Electric heating element; 11. Prompt module; 1101. Pressure sensor; 1102. Status indicator light; 12. Heat insulation pad; 13. Display screen.

### DETAILED DESCRIPTION OF THE EMBODIMENTS

The technical solutions of the embodiments of the present invention will be clearly and completely described below in conjunction with the accompanying drawings. It is evident that the described embodiments are merely a part of the embodiments of the present invention, not all of them. Based on the embodiments in the present invention, all other embodiments obtained by those skilled in the art without creative efforts shall fall within the scope of protection of the present invention.

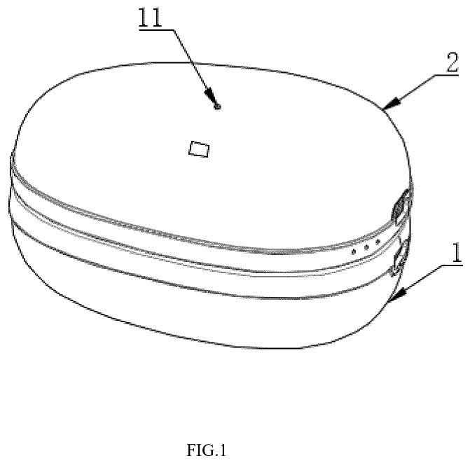

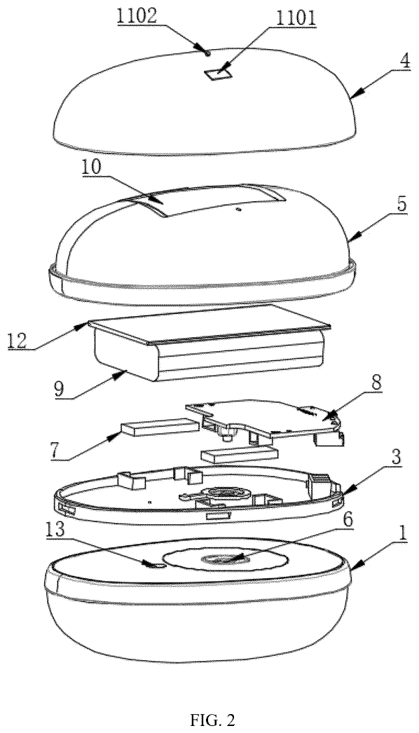

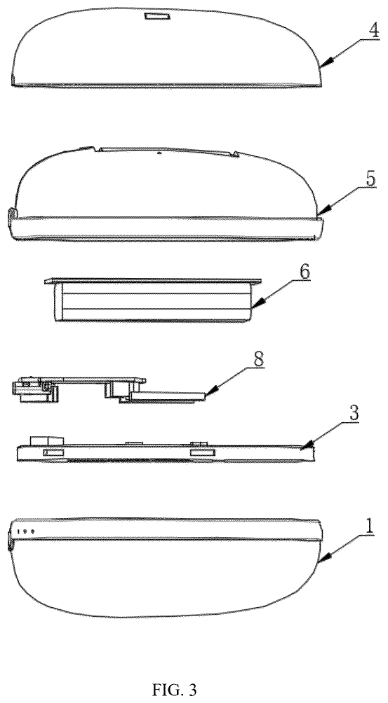

Referring to FIGS. 1 to 3, the present invention provides an energy-saving hand warmer, comprising a first shell (1) and a second shell (2). Both the first shell (1) and the second shell (2) are composed of a base plate (3), a first casing (4), and a second casing (5). Control buttons (6) and a display screen (13) for displaying battery level are installed on the outer side of the base plate (3). The heating and heating level can be controlled by the control buttons (6). The outer surface of the base plate (3) is equipped with two sets of slots, and the magnets (7) are embedded within these slots. The magnets (7) between the first shell (1) and the second shell (2) attract each other to connect. The circuit board (8) and a high-capacity battery (9) are conventionally integrated. A heat insulation pad (12) is installed on the surface of the side of the battery (9) that is close to the second casing (5) to protect the battery (9). The first shell (1) and the second shell (2) can be combined into a large hand warmer by magnetic attraction after fitting together, or they can be separated into two independent hand warmers for individual use, providing better adaptability.

The first casing (4) is fitted over the surface of the second casing (5), and an electric heating element (10) is installed between the first casing (4) and the second casing (5) to heat the first casing (4). A mounting groove is provided on the outer wall of the second casing (5), and the electric heating element (10) is installed in the mounting groove, ensuring that the outer wall of the electric heating element (10) fits closely with the inner wall of the first casing (4), thereby effectively transferring heat to the outer surface of the first casing (4).

The first shell (1) and the second shell (2) can be fitted together, with an integrated outer rim formed on the edge of the inner base plate (3) of the first shell (1). The outer rim can wrap around the exterior of another base plate (3), forming a fitting limit.

A prompt module (11) is installed on the first casing (4). The prompt module (11) includes two pressure sensors (1101) symmetrically installed on the surface of the first casing (4), and a status indicator light (1102) is also installed at the center of the top of the first casing (4). The pressure sensors (1101) and the status indicator light (1102) are connected to the circuit board (8) through wires.

In summary, during use, the first shell (1) and the second shell (2) can be magnetically attracted to form a large hand warmer after fitting together, or they can be separated into two independent hand warmers for separate use. There is a status indicator light (1102) on the outer surface of both the first shell (1) and the second shell (2), which remains illuminated during heating to remind the user that the device is in working condition, reducing the risk of forgetting to turn off the power after use. Additionally, pressure sensors (1101) are arranged in specific areas on the first shell (1) and the second shell (2). When the pressure sensors (1101) remain in a long-term idle state, the power is automatically disconnected to prevent energy waste.

The control method of the present invention is automatic control via a controller on the circuit board, interconnected by wires. The control circuit of the controller can be implemented through simple programming by those skilled in the art, and the power supply is also well-known knowledge in the field. Since this invention mainly aims to protect the mechanical device, detailed explanations of the control method and circuit connections are not provided.

It should be noted that, in this document, terms like “comprise,” “include,” or any variations thereof are intended to cover non-exclusive inclusion, so that a process, method, article, or device that includes a list of elements not only includes those elements but also other elements not expressly listed or inherent to such a process, method, article, or device.

Although embodiments of the present invention have been shown and described, it will be understood by those skilled in the art that various changes, modifications, substitutions, and alterations can be made to these embodiments without departing from the principles and spirit of the present invention. The scope of the present invention is defined by the appended claims and their equivalents.

What is claimed is:

1. An energy-saving hand warmer, comprising a first shell (1) and a second shell (2), characterized in that: the first shell (1) and the second shell (2) are both composed of a base plate (3), a first casing (4), and a second casing (5); The outer side of the base plate (3) is provided with control buttons (6); The base plate (3) is equipped with two rectangular magnets (7), a circuit board (8), and a battery (9); The first casing (4) is fitted over the surface of the second casing (5), and an electric heating element (10) is arranged between the first casing (4) and the second casing (5) to heat the first casing (4); Additionally, a prompt module (11) is arranged on the first casing (4) to detect whether the hand warmer is turned on.

2. The energy-saving hand warmer according to claim 1, characterized in that: the surface of the base plate (3) is provided with two sets of slots, and the magnets (7) are embedded in the slots.

3. The energy-saving hand warmer according to claim 1, characterized in that: one side surface of the battery (9), which is close to the second casing (5), is provided with a heat insulation pad (12).

4. The energy-saving hand warmer according to claim 1, characterized in that: the outer wall of the second casing (5) is provided with a mounting groove, and the electric heating element (10) is arranged in the mounting groove, with the outer wall of the electric heating element (10) fitting against the inner wall of the first casing (4).

5. The energy-saving hand warmer according to claim 1, characterized in that: the edge of the inner base plate (3) of the first shell (1) is provided with an outer rim, and the sides of the first shell (1) and the second shell (2) that are close to each other are fitted together through the outer rim.

6. The energy-saving hand warmer according to claim 1, characterized in that: the prompt module (11) includes two pressure sensors (1101) symmetrically installed on the surface of the first casing (4), and a status indicator light (1102) is also arranged at the center of the top of the first casing (4).

7. The energy-saving hand warmer according to claim 1, characterized in that: the outer side of the base plate (3) is further provided with a display screen (13) for showing the battery level.
